(19) United States
(12) Patent Application Publication
(10) Pub. No.: US 2022/0237666 A1
(43) Pub. Date: Jul. 28, 2022

(54) Advertising System and Method

(71) Applicant: Good-Loop Ltd., Edinburgh (GB)

(72) Inventors: Daniel Ben Winterstein, Edinburgh (GB); Amy Frances Williams, London (GB)

(21) Appl. No.: 17/581,141

(22) Filed: Jan. 21, 2022

Related U.S. Application Data
(60) Provisional application No. 63/140,622, filed on Jan. 22, 2021.

(51) Int. Cl. G06Q 30/02

(52) U.S. Cl. CPC G06Q 30/0275; G06Q 30/0255; G06Q 30/0277; G06Q 30/0279

(57) ABSTRACT

A computer-implemented method, computer program product and computing system for obtaining advert target information for a primary advert auction concerning a viewer of content, wherein the primary advert auction solicits bids for providing an advertisement to the viewer of the content, thus resulting in one or more primary bids; initiating a secondary advert auction based, at least in part, upon the advert target information, wherein the secondary advert auction solicits bids for providing the advertisement to the viewer of the content while requiring a donation to a charity, thus resulting in one or more secondary bids; and inserting at least one of the secondary bids into the one or more primary bids so that the at least one of the secondary bids may be considered when determining a winner of the primary advert auction.

### RELATED APPLICATION(S)

This application claims the benefit of U.S. Provisional Application No. 63/140,622 filed on 22 Jan. 2021, the entire contents of which are incorporated herein by reference.

### TECHNICAL FIELD

This disclosure relates to advertising systems and methods and, more particularly, to advertising systems and methods that result in donations to charity.

### BACKGROUND

Much of the internet is funded via advertisement revenue, wherein such advertisements are often inserted/provided when viewers are reviewing online content. These advertisements may be static advertisements and/or video advertisements that may be presented to the viewer in various ways (e.g., popup windows, banner ads, embedded video content, etc.).

The specific advertisements that are presented to the viewer may be governed by manual advertisement insertion deals between the publishers of online content and various advertising entities. Unfortunately, such advertisements are often seen by the viewer as an annoyance/interruption, as there is not incentivization for the viewer to review the advertisement.

### SUMMARY OF DISCLOSURE

In one implementation, a computer-implemented method is executed on a computing device and includes: obtaining advert target information for a primary advert auction concerning a viewer of content, wherein the primary advert auction solicits bids for providing an advertisement to the viewer of the content, thus resulting in one or more primary bids; initiating a secondary advert auction based, at least in part, upon the advert target information, wherein the secondary advert auction solicits bids for providing the advertisement to the viewer of the content while requiring a donation to a charity, thus resulting in one or more secondary bids; and inserting at least one of the secondary bids into the one or more primary bids so that the at least one of the secondary bids may be considered when determining a winner of the primary advert auction.

One or more of the following features may be included. Inserting at least one of the secondary bids into the one or more primary bids so that the at least one of the secondary bids may be considered when determining a winner of the primary advert auction may include: inserting all of the secondary bids into the one or more primary bids so that all of the secondary bids may be considered when determining a winner of the primary advert auction. If one of the secondary bids is determined to be the winner of the primary advert auction, an offer to make the donation to the charity in exchange for the viewer of the content watching the advertisement may be made. The viewer of the content may be enabled to select the charity. Enabling the viewer of the content to select the charity may include: enabling the viewer of the content to select the charity from a plurality of predefined charities. Enabling the viewer of the content to select the charity may include: enabling the viewer of the content to predefine a preferred charity. The advert target information may include one or more of: demographic information concerning the viewer; viewing information concerning the content; and platform information. The advert target information may be defined within an advert auction offer for bids. The donation to the charity may be based upon a percentage of a secondary bid. The donation to the charity may be a fixed amount.

In another implementation, a computer program product resides on a computer readable medium and has a plurality of instructions stored on it. When executed by a processor, the instructions cause the processor to perform operations including obtaining advert target information for a primary advert auction concerning a viewer of content, wherein the primary advert auction solicits bids for providing an advertisement to the viewer of the content, thus resulting in one or more primary bids; initiating a secondary advert auction based, at least in part, upon the advert target information, wherein the secondary advert auction solicits bids for providing the advertisement to the viewer of the content while requiring a donation to a charity, thus resulting in one or more secondary bids; and inserting at least one of the secondary bids into the one or more primary bids so that the at least one of the secondary bids may be considered when determining a winner of the primary advert auction.

One or more of the following features may be included. Inserting at least one of the secondary bids into the one or more primary bids so that the at least one of the secondary bids may be considered when determining a winner of the primary advert auction may include: inserting all of the secondary bids into the one or more primary bids so that all of the secondary bids may be considered when determining a winner of the primary advert auction. If one of the secondary bids is determined to be the winner of the primary advert auction, an offer to make the donation to the charity in exchange for the viewer of the content watching the advertisement may be made. The viewer of the content may be enabled to select the charity. Enabling the viewer of the content to select the charity may include: enabling the viewer of the content to select the charity from a plurality of predefined charities. Enabling the viewer of the content to select the charity may include: enabling the viewer of the content to predefine a preferred charity. The advert target information may include one or more of: demographic information concerning the viewer; viewing information concerning the content; and platform information. The advert target information may be defined within an advert auction offer for bids. The donation to the charity may be based upon a percentage of a secondary bid. The donation to the charity may be a fixed amount.

In another implementation, a computing system includes a processor and a memory system configured to perform operations including obtaining advert target information for a primary advert auction concerning a viewer of content, wherein the primary advert auction solicits bids for providing an advertisement to the viewer of the content, thus resulting in one or more primary bids; initiating a secondary advert auction based, at least in part, upon the advert target information, wherein the secondary advert auction solicits bids for providing the advertisement to the viewer of the content while requiring a donation to a charity, thus resulting in one or more secondary bids; and inserting at least one of the secondary bids into the one or more primary bids so that the at least one of the secondary bids may be considered when determining a winner of the primary advert auction.

One or more of the following features may be included. Inserting at least one of the secondary bids into the one or more primary bids so that the at least one of the secondary bids may be considered when determining a winner of the primary advert auction may include: inserting all of the secondary bids into the one or more primary bids so that all of the secondary bids may be considered when determining a winner of the primary advert auction. If one of the secondary bids is determined to be the winner of the primary advert auction, an offer to make the donation to the charity in exchange for the viewer of the content watching the advertisement may be made. The viewer of the content may be enabled to select the charity. Enabling the viewer of the content to select the charity may include: enabling the viewer of the content to select the charity from a plurality of predefined charities. Enabling the viewer of the content to select the charity may include: enabling the viewer of the content to predefine a preferred charity. The advert target information may include one or more of: demographic information concerning the viewer; viewing information concerning the content; and platform information. The advert target information may be defined within an advert auction offer for bids. The donation to the charity may be based upon a percentage of a secondary bid. The donation to the charity may be a fixed amount.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes an advertising process according to an embodiment of the present disclosure;

FIG. 2 is a diagrammatic view of an advertisement auction platform accessible by the advertising process of FIG. 1 according to an embodiment of the present disclosure;

and

FIG. 3 is a flowchart of the advertising process of FIG. 1 according to an embodiment of the present disclosure.

Like reference symbols in the various drawings indicate like elements.

### DETAILED DESCRIPTION OF THE PREFERRED EMBODIMENTS

System Overview

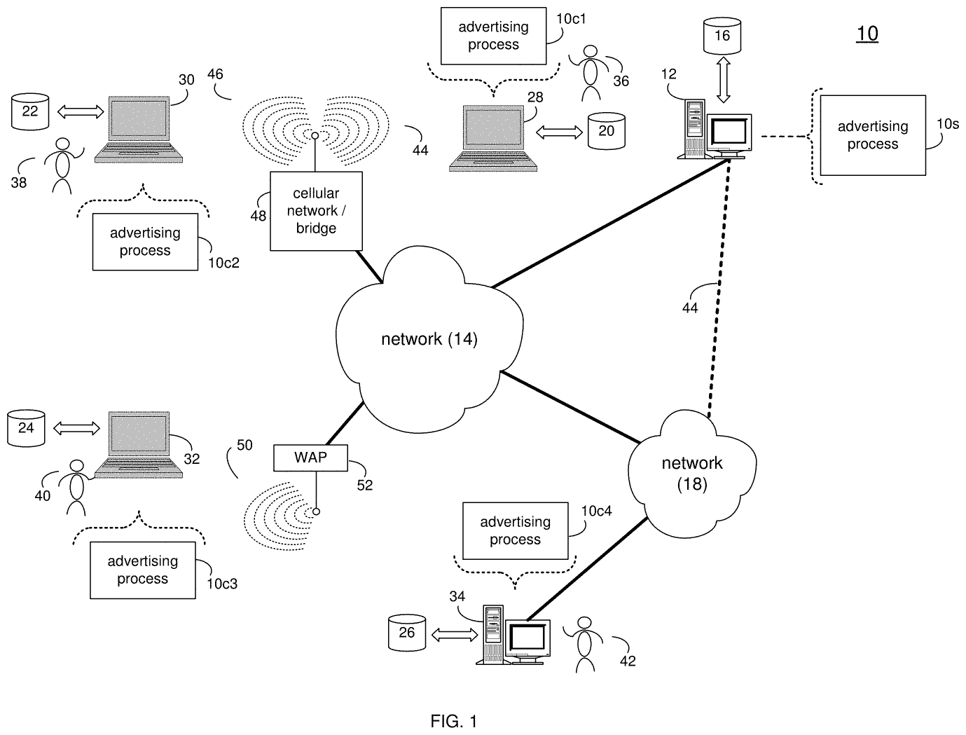

Referring to FIG. 1, there is shown advertising process 10. Advertising process 10 may be implemented as a server-side process, a client-side process, or a hybrid server-side/client-side process. For example, advertising process 10 may be implemented as a purely server-side process via advertising process 10s. Alternatively, advertising process 10 may be implemented as a purely client-side process via one or more of advertising process 10c1, advertising process 10c2, advertising process 10c3, and advertising process 10c4. Alternatively still, advertising process 10 may be implemented as a hybrid server-side/client-side process via advertising process 10s in combination with one or more of advertising process 10c1, advertising process 10c2, advertising process 10c3, and advertising process 10c4. Accordingly, advertising process 10 as used in this disclosure may include any combination of advertising process 10s, advertising process 10c1, advertising process 10c2, advertising process 10c3, and advertising process 10c4.

Advertising process 10s may be a server application and may reside on and may be executed by computing device 12, which may be connected to network 14 (e.g., the Internet or a local area network). Examples of computing device 12 may include, but are not limited to: a personal computer, a server computer, a series of server computers, a mini computer, a mainframe computer, a smartphone, or a cloud-based computing platform.

The instruction sets and subroutines of advertising process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of advertising processes 10c1, 10c2, 10c3, 10c4 may include but are not limited to a web browser, a game console user interface, a mobile device user interface, or a specialized application (e.g., an application running on e.g., the Android™ platform, the iOS™ platform, the Windows™ platform, the Linux™ platform or the UNIX cm platform). The instruction sets and subroutines of advertising processes 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; RAID devices; random access memories (RAM); read-only memories (ROM), and all forms of flash memory storage devices.

Examples of client electronic devices 28, 30, 32, 34 may include, but are not limited to, a smartphone (not shown), a personal digital assistant (not shown), a tablet computer (not shown), laptop computers 28, 30, 32, personal computer 34, a notebook computer (not shown), a server computer (not shown), a gaming console (not shown), and a dedicated network device (not shown). Client electronic devices 28, 30, 32, 34 may each execute an operating system, examples of which may include but are not limited to Microsoft Windows™, Android™, iOS™, Linux™, or a custom operating system.

Users 36, 38, 40, 42 may access advertising process 10 directly through network 14 or through secondary network 18. Further, advertising process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, laptop computer 28 and laptop computer 30 are shown wirelessly coupled to network 14 via wireless communication channels 44, 46 (respectively) established between laptop computers 28, 30 (respectively) and cellular network/bridge 48, which is shown directly coupled to network 14. Further, laptop computer 32 is shown wirelessly coupled to network 14 via wireless communication channel 50 established between laptop computer 32 and wireless access point (i.e., WAP) 52, which is shown directly coupled to network 14. Additionally, personal computer 34 is shown directly coupled to network 18 via a hardwired network connection.

WAP 52 may be, for example, an IEEE 802.11a, 802.11b, 802.11g, 802.11n, Wi-Fi, and/or Bluetooth device that is capable of establishing wireless communication channel 50 between laptop computer 32 and WAP 52. As is known in the art, IEEE 802.11x specifications may use Ethernet protocol and carrier sense multiple access with collision avoidance (i.e., CSMA/CA) for path sharing. As is known in the art, Bluetooth is a telecommunications industry specification that allows e.g., mobile phones, computers, and personal digital assistants to be interconnected using a short-range wireless connection.

Traditional Advertising Auction Process (Overview)

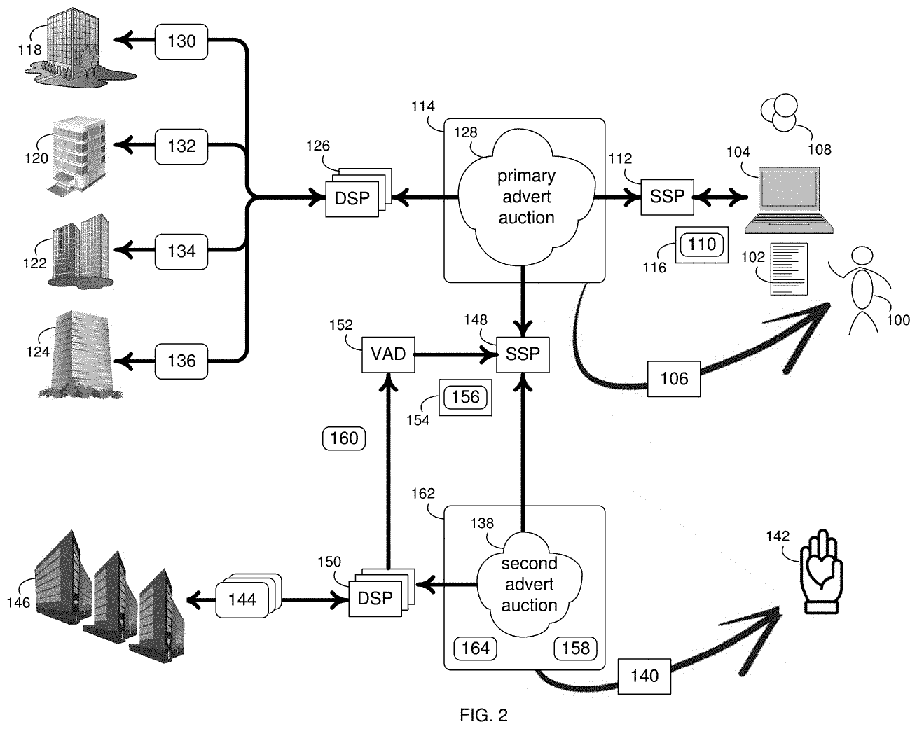

Referring also to FIG. 2, assume for illustrative purposes that a viewer (e.g., viewer 100) is viewing content (e.g., content 102) on a computing platform (e.g., platform 104). Examples of content 102 may include but are not limited to audio content, video content, graphical content and/or text-based content. Examples of platform 104 may include but are not limited to: a personal computer, a laptop computer, a notebook computer, a tablet computer, a smartphone, or a cloud-based computing platform.

As is known in the art, advertisements (e.g., advertisement 106) are typically targeted toward the likes and the interests of the recipient of the advertisement. Examples of advertisement 106 may include but are not limited to audio advertisements, video advertisements, graphical advertisements and/or text-based advertisements. Accordingly, the publisher of content 102 may identify the subject matter of content 102 so that advertisements (e.g., advertisement 106) related to the subject matter of content 102 may be directed to the viewer (e.g., viewer 100). Therefore, if the viewer (e.g., viewer 100) is reviewing content (e.g., content 102) concerning guitars, advertising process 10 may provide guitar-related advertisements (e.g., advertisement 106) to viewer 100; if the viewer (e.g., viewer 100) is reviewing content (e.g., content 102) concerning cars, advertising process 10 may provide car-related advertisements (e.g., advertisement 106) to viewer 100; and if the viewer (e.g., viewer 100) is reviewing content (e.g., content 102) concerning sports, advertising process 10 may provide sports-related advertisements (e.g., advertisement 106) to viewer 100. Accordingly, advertising process 10 may monitor the content (e.g., content 102) that the viewer (e.g., viewer 100) is reviewing and provide advertisements (e.g., advertisement 106) to viewer 100 that are related to that content (e.g., content 102).

For the following example, assume that the viewer (e.g., viewer 100) is reading a web-based article (e.g., content 102) concerning guitars on their laptop computer (e.g., platform 104). Further assume that their laptop computer (e.g., platform 104) includes various cookies (e.g., cookies 108) that identify the viewer (e.g., viewer 100) as a 35-45 year old male who lives in Connecticut and their laptop computer (e.g., platform 104) as a HP™ model ABC123 that is running Windows 11™.

As is known in the art, cookies (e.g., cookies 108) are text files with small pieces of data (e.g., a username, a password, demographic information) that are used to improve a viewer's experience as the viewer uses e.g., a computer network, a computer application, and/or a website by identifying the viewer (e.g., viewer 100), the viewer's computer (e.g., platform 104) and the viewer's preferences in general. Data stored in a cookie (e.g., cookies 108) may be created by a remote server (not shown) upon connection, wherein this data may be labeled with an ID unique to the viewer (e.g., viewer 100) and their computer (e.g., platform 104). When cookies (e.g., cookies 108) are exchanged between platform 104 and the remote server (not shown), the remote server (not shown) may read the information included within the cookies (e.g., cookies 108) so that the remote server (not shown) knows what information to serve to the viewer (e.g., viewer 100).

This information (e.g., demographic information concerning viewer 100; viewing information concerning content 102; and/or platform information concerning platform 104) may be packaged to form advert target information 110. Accordingly, advert target information 110 may identify the viewer (e.g., viewer 100) and define what they are currently doing and what platform they are currently using, wherein this advert target information 110 may be used to provide advertisements (e.g., advertisement 106) to viewer 100 that are related to that content (e.g., content 102).

Advert target information 110 may be provided, via supply side platform (SSP) 112, to auction platform 114. For example, advert target information 110 may be defined within an advert auction offer (e.g., advert auction offer 116) that is provided to auction platform 114. As is known in the art, supply side platform 112 is a platform that enables publishers (e.g., publishers of content 102) to sell advertising space (via auction platform 114) to the consumers (e.g., viewer 100) of such content (e.g., content 102), thus providing an advertiser (e.g., one of advertisers 118, 120, 122, 124) with the ability to provide e.g., advertisement 106 to viewer 100.

Demand side platform (DSP) 126 may enable the advertisers (e.g., one of advertisers 118, 120, 122, 124) to buy media space (via auction platform 114), thus enabling one of the advertisers (e.g., one of advertisers 118, 120, 122, 124) to provide e.g., advertisement 106 to viewer 100.

As is known in the art, auction platform 114 is a marketplace where DSPs (e.g., demand side platform 126) and SSPs (e.g., supply side platform 112) trade, usually via auctions (e.g., primary advert auction 128). For example and continuing with the above-discussed example in which viewer 100 is reading content 102 concerning guitars on platform 104, the publisher of content 102 may provide advert target information 110 to auction platform 114 via supply side platform 112. Advert target information 110 may define viewer 100 as a 35-45 year old male who lives in Connecticut and uses an HP™ model ABC123 laptop (e.g., platform 104) that is running Windows 11™ to review content 102, which is an article about guitars.

Accordingly, auction platform 114 may initiate primary advert auction 128 to enable the advertisers to submit bids (e.g., bids 130, 132, 134, 136) concerning primary advert auction 128, wherein these bids (e.g., bids 130, 132, 134, 136) may define the amount that an advertiser is willing to pay for the ability to provide e.g., advertisement 106 to viewer 100. For example, assume that:
advertiser 118 submits a bid (e.g., bid 130) of $0.01 for the ability to provide advertisement 106 to viewer 100, as advertiser 118 is slightly interested because content 102 concerns guitars . . . so advertiser 118 wants to insert an advertisement (e.g., advertisement 106) for a US-based guitar company they represent;
advertiser 120 submits a bid (e.g., bid 132) of $0.03 for the ability to provide advertisement 106 to viewer 100, as advertiser 120 is moderately interested because content 102 concerns guitars and viewer 100 is located in Connecticut . . . so advertiser 120 wants to insert an advertisement (e.g., e.g., advertisement 106) for a local Connecticut guitar company they represent;
advertiser 122 submits a bid (e.g., bid 134) of $0.08 for the ability to provide advertisement 106 to viewer 100, as advertiser 122 is highly interested because content 102 concerns guitars and viewer 100 is a 35-45 year old male . . . so advertiser 122 wants to insert an advertisement (e.g., e.g., advertisement 106) for an Arizona-based Rock-n-Roll fantasy camp they represent; and
advertiser 124 submits a bid (e.g., bid 136) of $0.10 for the ability to provide advertisement 106 to viewer 100, as advertiser 124 is extremely interested because content 102 concerns guitars and viewer 100 is a 35-45 year old male who lives in Connecticut . . . so advertiser 124 wants to insert an advertisement (e.g., e.g., advertisement 106) for a Connecticut-based Rock-n-Roll fantasy camp they represent.

Auction platform 114 may review these bids (e.g., bids 130, 132, 134, 136) and select the highest bid (e.g., bid 136) and the high bidder (e.g., advertiser 124) as the winner of primary advert auction 126, thus providing advertiser 124 with the ability to provide advertisement 106 (e.g., an advertisement for a Connecticut-based Rock-n-Roll fantasy camp that advertiser 124 represents) to viewer 100 of content 102.

Enhanced Advertising Auction Process

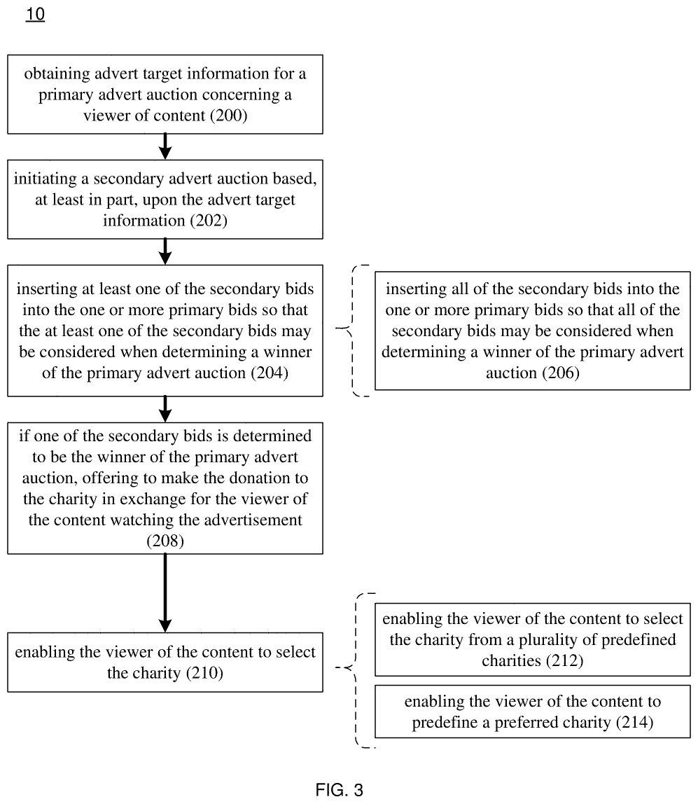

Referring also to FIG. 3 and as discussed above, advertising process 10 may obtain 200 advert target information (e.g., advert target information 110) for a primary advert auction (e.g., primary advert auction 128) concerning a viewer (e.g., viewer 100) of content (e.g., content 102) on a computing platform (e.g., platform 104). As also discussed above, this primary advert auction (e.g., primary advert auction 128) may solicit bids for providing an advertisement (e.g., e.g., advertisement 106) to the viewer (e.g., viewer 100) of the content (e.g., content 102), thus resulting in one or more primary bids (e.g., bids 130, 132, 134, 136).

As also discussed above, examples of content 102 may include but are not limited to audio content, video content, graphical content and/or text-based content, wherein examples of platform 104 may include but are not limited to: a personal computer, a laptop computer, a notebook computer, a tablet computer, a smartphone, or a cloud-based computing platform.

As also discussed above, the advert target information (e.g., advert target information 110) may include one or more of: demographic information concerning the viewer (e.g., viewer 100); viewing information concerning the content (e.g., content 102); and platform information (e.g., concerning platform 104), wherein this advert target information (e.g., advert target information 110) may be defined within advert auction offer 116 for bids (e.g., bids 130, 132, 134, 136).

Additionally, advertising process 10 may initiate 202 a secondary advert auction (e.g., secondary advert auction 138) based, at least in part, upon the advert target information (e.g., advert target information 110), wherein the secondary advert auction (e.g., secondary advert auction 138) solicits bids for providing the advertisement (e.g., e.g., advertisement 106) to the viewer (e.g., viewer 100) of the content (e.g., content 102) while requiring a donation (e.g., donation 140) to a charity (e.g., charity 142), thus resulting in one or more secondary bids (e.g., secondary bids 144). As will be discussed below in greater detail, the donation (e.g., donation 140) to the charity (e.g., charity 142) may be based upon a percentage of a secondary bid (e.g., one of secondary bids 144) and/or a fixed amount. The duration of secondary advert auction 138 may be shorter (e.g., 50 milliseconds) than the duration of primary advert auction 128 (e.g., 100 milliseconds). Additionally, secondary advert auction 138 may be effectuated through the same auction platform (e.g., auction platform 114) as primary advert auction 128.

For example and upon the initiation 202 of the secondary advert auction (e.g., secondary advert auction 138) based, at least in part, upon the advert target information (e.g., advert target information 110), various advertisers (e.g., one or more of advertisers 146) may submit bids (e.g., secondary bids 144) for providing advertisement 106 to viewer 100 of content 102, wherein all of these bids (e.g., secondary bids 144) must include a donation component (e.g., donation 140). For example, this donation component (e.g., donation 140) may be a percentage of the winning bid (e.g., 50% of the winning bid amount is donated to charity 142) or a fixed amount (e.g., $0.05 of the winning bid amount is donated to charity 142).

The secondary advert auction (e.g., secondary advert auction 138) may utilize a supply side platform (e.g., supply side platform 148) to enable publishers (e.g., publishers of content 102) to sell advertising space (via secondary advert auction 138) to the consumers (e.g., viewer 100) of such content (e.g., content 102) and/or a demand side platform (e.g., demand side platform 150) to enable the advertisers (e.g., one or more of advertisers 146) to buy media space (via secondary advert auction 138), thus enabling one of the advertisers (e.g., one of advertisers 146) to provide e.g., advertisement 106 to viewer 100.

As discussed above, the duration of secondary advert auction 138 may be shorter (e.g., 50 milliseconds) than the duration of primary advert auction 128 (e.g., 100 milliseconds). Accordingly, secondary advert auction 138 may end BEFORE primary advert auction 128. Accordingly, advertising process 10 may insert 204 at least one of the secondary bids (e.g., at least one of secondary bids 144) into the one or more primary bids (e.g., bids 130, 132, 134, 136) so that the at least one of the secondary bids (e.g., at least one of secondary bids 144) may be considered when determining a winner of the primary advert auction (e.g., primary advert auction 128).

As discussed above:
advertiser 118 submits a bid (e.g., bid 130) of $0.01 for the ability to provide advertisement 106 to viewer 100, as advertiser 118 is slightly interested because content 102 concerns guitars . . . so advertiser 118 wants to insert an advertisement (e.g., advertisement 106) for a US-based guitar company they represent;
advertiser 120 submits a bid (e.g., bid 132) of $0.03 for the ability to provide advertisement 106 to viewer 100, as advertiser 120 is moderately interested because content 102 concerns guitars and viewer 100 is located in Connecticut . . . so advertiser 120 wants to insert an advertisement (e.g., e.g., advertisement 106) for a local Connecticut guitar company they represent;
advertiser 122 submits a bid (e.g., bid 134) of $0.08 for the ability to provide advertisement 106 to viewer 100, as advertiser 122 is highly interested because content 102 concerns guitars and viewer 100 is a 35-45 year old male . . . so advertiser 122 wants to insert an advertisement (e.g., e.g., advertisement 106) for an Arizona-based Rock-n-Roll fantasy camp they represent; and
advertiser 124 submits a bid (e.g., bid 136) of $0.10 for the ability to provide advertisement 106 to viewer 100, as advertiser 124 is extremely interested because content 102 concerns guitars and viewer 100 is a 35-45 year old male who lives in Connecticut . . . so advertiser 124 wants to insert an advertisement (e.g., e.g., advertisement 106) for a Connecticut-based Rock-n-Roll fantasy camp they represent.

Further, assume that:
a first of advertisers 146 submits a bid (e.g., a first of secondary bids 144) of $0.13 for the ability to provide advertisement 106 to viewer 100, as the first of advertisers 146 is moderately interested because content 102 concerns guitars and the first of advertisers 146 is moderately motivated to give back in the form of donations to (in this example) charity 142 . . . so the first of advertisers 146 wants to insert an advertisement (e.g., e.g., advertisement 106) for a local New Hampshire guitar company they represent; and
a second of advertisers 146 submits a bid (e.g., a second of secondary bids 144) of $0.16 for the ability to provide advertisement 106 to viewer 100, as the second of advertisers 146 is extremely interested because content 102 concerns guitars and the second of advertisers 146 is extremely motivated to give back in the form of donations to (in this example) charity 142 . . . so the second of advertisers 146 wants to insert an advertisement (e.g., e.g., advertisement 106) for a local Massachusetts guitar company they represent.

When inserting 204 at least one of the secondary bids (e.g., at least one of secondary bids 144) into the one or more primary bids (e.g., bids 130, 132, 134, 136) so that the at least one of the secondary bids (e.g., at least one of secondary bids 144) may be considered when determining a winner of the primary advert auction (e.g., primary advert auction 128), advertising process 10 may insert 206 all of the secondary bids (e.g., all of secondary bids 144) into the one or more primary bids (e.g., bids 130, 132, 134, 136) so that all of the secondary bids (e.g., all of secondary bids 144) may be considered when determining a winner of the primary advert auction (e.g., primary advert auction 128).

As discussed above, a first of advertisers 146 submits a bid (e.g., a first of secondary bids 144) of $0.13 for the ability to provide advertisement 106 to viewer 100, while a second of advertisers 146 submits a bid (e.g., a second of secondary bids 144) of $0.16 for the ability to provide advertisement 106 to viewer 100. Accordingly and in such an implementation, both of secondary bids 144 (e.g., the $0.13 bid and the $0.16 bid) may be inserted 204 into the one or more primary bids (e.g., bids 130, 132, 134, 136) so that both of secondary bids 144 (e.g., the $0.13 bid and the $0.16 bid) may be considered when determining a winner of the primary advert auction (e.g., primary advert auction 128).

Alternatively, only the winning (e.g., the highest) of the secondary bids (e.g., secondary bids 144) may be inserted 204 into the one or more primary bids (e.g., bids 130, 132, 134, 136) so that this winning (e.g., the highest) of the secondary bids (e.g., secondary bids 144) may be considered when determining a winner of the primary advert auction (e.g., primary advert auction 128).

As discussed above, a first of advertisers 146 submits a bid (e.g., a first of secondary bids 144) of $0.13 for the ability to provide advertisement 106 to viewer 100, while a second of advertisers 146 submits a bid (e.g., a second of secondary bids 144) of $0.16 for the ability to provide advertisement 106 to viewer 100. Accordingly and in such an implementation, only one of the secondary bids 144 (e.g., the $0.16 bid) may be inserted 204 into the one or more primary bids (e.g., bids 130, 132, 134, 136) so that only one of the secondary bids 144 (e.g., the $0.16 bid) may be considered when determining a winner of the primary advert auction (e.g., primary advert auction 128).

If one of the secondary bids (e.g., one of secondary bids 144) is determined to be the winner of the primary advert auction (e.g., primary advert auction 128), advertising process 10 may offer 208 to make the donation (e.g., donation 140) to the charity (e.g., charity 142) in exchange for the viewer (e.g., viewer 100) of the content (e.g., content 102) watching the advertisement (e.g., e.g., advertisement 106).

For example, assume that the charity (e.g., charity 142) is the American Society for the Prevention of Cruelty to Animals (ASPCA) and that the donation (e.g., donation 140) is a fixed amount (e.g., $0.05 of the winning bid amount is donated to charity 142). Accordingly, the primary bids (e.g., bids 130, 132, 134, 136) have values of $0.01, $0.03, $0.08 and $0.10 (respectively). As these primary bids (e.g., bids 130, 132, 134, 136) do not have a donation component, assume that the entire amount of these bids (less any administrative fees) is provided to the publisher of content 102, namely of $0.01, $0.03, $0.08 and $0.10 (respectively).

For this example, assume that advertising process 10 inserts 206 all of the secondary bids (e.g., all of secondary bids 144) into the one or more primary bids (e.g., bids 130, 132, 134, 136) so that all of the secondary bids (e.g., all of secondary bids 144) may be considered when determining a winner of the primary advert auction (e.g., primary advert auction 128). Accordingly, both of secondary bids 144 (e.g., the $0.13 bid and the $0.16 bid) may be inserted 204 into the one or more primary bids (e.g., bids 130, 132, 134, 136) so that both of secondary bids 144 (e.g., the $0.13 bid and the $0.16 bid) may be considered when determining a winner of the primary advert auction (e.g., primary advert auction 128).

As discussed above, assume for this example that the donation (e.g., donation 140) is a fixed amount (e.g., $0.05 of the winning bid amount is donated to charity 142). As both of secondary bids 144 (e.g., the $0.13 bid and the $0.16 bid) include a $0.05 donation component donation (e.g., donation 140), a smaller portion of these bids (less any administrative fees) is provided to the publisher of content 102. For example, $0.08 of the $0.13 bid is provided to the publisher of content 102, while $0.11 of the $0.16 bid is provided to the publisher of content 102.

Continuing with the above-stated example, as $0.11 of the $0.16 bid (e.g., the second of secondary bids 144) is provided to the publisher of content 102, advertising process 10 may determine this bid to be the winning bid within primary advert auction 128 (as $0.11 being provided to the publisher of content 102 exceeds $0.10 being provided to the publisher of content 102 via bid 136). Accordingly, advertising process 10 may determine this bid to be the winning bid within primary advert auction 128 (as $0.11 is provided to the publisher of content 102), thus enabling the second of advertisers 146 to provide advertisement 106 to viewer 100, wherein viewer 100 may be asked to (or enticed into) watching advertisement 106 by the offer of making a donation (e.g., donation 140) to a charity (e.g., charity 142).

For example, advertising process 10 may enable 210 the viewer (e.g., viewer 100) of the content (e.g., content 102) to select the charity (e.g., charity 142). For example and when enabling 210 the viewer (e.g., viewer 100) of the content (e.g., content 102) to select the charity (e.g., charity 142), advertising process 10 may enable 212 the viewer (e.g., viewer 100) of the content (e.g., content 102) to select the charity (e.g., charity 142) from a plurality of predefined charities. Alternatively and when enabling 212 the viewer (e.g., viewer 100) of the content (e.g., content 102) to select the charity (e.g., charity 142), advertising process 10 may enable 214 the viewer (e.g., viewer 100) of the content (e.g., content 102) to predefine a preferred charity.

For example and while viewer 100 is reviewing content 102 (e.g., an article concerning guitars), advertising process 10 may present viewer 100 with the opportunity to watch advertisement 106 in exchange for donation 140 being made to charity 142. Accordingly and if viewer 100 has a predefined charity (e.g., in their user profile), advertising process 10 may enable 214 viewer 100 of content 102 to make donation 140 this predefined charity (e.g., charity 142). Alternatively and if viewer 100 does not have a predefined charity (e.g., if a new user and/or does not have a profile-defined charity), advertising process 10 may provide viewer 100 with a list of available charities (e.g., a) American Society for the Prevention of Cruelty to Animals, b) the World Wildlife Fund, c) Saint Jude's Children's Hospital, and d) the Wounded Warrior Project) and enable 212 viewer 100 of content 102 to select a charity (e.g., charity 142) from this plurality of predefined charities (e.g., a) American Society for the Prevention of Cruelty to Animals, b) the World Wildlife Fund, c) Saint Jude's Children's Hospital, and d) the Wounded Warrior Project).

Once the viewer (e.g., viewer 100) watches advertisement 106, advertising process 10 may make donation 140 to charity 142. For example, advertising process 10 may require viewer 100 to completely watch advertisement 106 before donation 140 is made to charity 142, Alternatively, advertising process 10 may require viewer 100 to at least partially watch advertisement 106 before donation 140 is made to charity 142.

### Illustrative Implementation Examples

There are many different ways in which advertising process 10 may be implemented, wherein these various implementations may provide various benefits. Accordingly, the following are illustrative examples of the manner in which advertising process 10 may be implemented.

Nested Ad-Tags
The viewer (e.g., viewer 100) may visit a web page (e.g., content 102).
The web page (e.g., content 102) may contain an SSP ad tag (e.g., included within advert target information 110), which may request an advert (e.g., advertisement 106) from an Ad-Exchange (e.g., auction platform 114).
The Ad-Exchange (e.g., auction platform 114) may send bid requests (not shown) to multiple DSPs (e.g., DSPs 126).
The DSPs (e.g., DSP 126) may submit bids (e.g., bids 130, 132, 134, 136) concerning what they will pay to insert an advert (e.g., advertisement 106).
A Value-Add Distributor (e.g., VAD 152) may also submit a bid (e.g., bid 144).
The Ad-Exchange (e.g., auction platform 114) may pick the highest bid, and may connect the winning DSP (e.g., DSP 126/DSP 150) to the SSP ad tag (e.g., included within advert target information 110).

If the winning bid was from the Value-Add Distributor (e.g., VAD 152):
The Value-Add Distributor (e.g., VAD 152) may deliver a first creative tag (e.g., creative tag 154) to the SSP ad tag (e.g., included within advert target information 110), wherein this first creative tag (e.g., creative tag 154) may contain its own SSP ad tag (e.g., nested SSP ad tag 156).
The nested SSP ad tag (e.g., nested SSP ad tag 156) may request an advert (e.g., advertisement 106) from the Ad-Exchange (e.g., auction platform 114), wherein this nested SSP ad tag (e.g., nested SSP ad tag 156) may specify a Deal-ID (e.g., Deal-ID 158).
The DSP (e.g., DSP 150) for that Deal-ID (e.g., Deal-ID 158) may submit a bid (e.g., bid 144) for what they will pay to the Ad-Exchange (e.g., auction platform 114) to insert an advert (e.g., advertisement 106). This bid (e.g., bid 144) may include payment for the extra value (e.g., donation 140) provided by the Value-Add Distributor (e.g., VAD 152).
The Ad-Exchange (e.g., auction platform 114) may pick the highest bid, and may connect the winning DSP (e.g., DSP 150) to the nested SSP ad tag (e.g., nested SSP ad tag 156), wherein the winning DSP (e.g., DSP 150) may send the advertiser creative (e.g., advertiser creative 160) to the nested SSP ad tag (e.g., nested SSP ad tag 156).
The first creative tag (e.g., creative tag 154) may display the advertiser creative (e.g., advertisement 106), wherein this display may include extra framing elements, interactivity, and modifications added by the first creative tag (e.g., creative tag 154).

The use of a Deal-ID (e.g., Deal-ID 158) may provide a way to control across the two auctions (e.g., advert auctions 128, 138) what final creative (e.g., advertisement 106) is delivered to viewer (e.g., viewer 100). If a Deal-ID (e.g., Deal-ID 158) is not specified, a nested marketplace may be run, which may require consent from the Ad-Exchange (e.g., auction platform 114) to avoid breaking safety rules around changing creative content.

Deal Labelling within an Ad-Exchange
The viewer (e.g., viewer 100) may visit a web page (e.g., content 102).
The web page (e.g., content 102) may contain an SSP ad tag (e.g., included within advert target information 110), which may request an advert (e.g., advertisement 106) from the Curation Ad-Exchange (e.g., auction platform 162)
The Curation Ad-Exchange (e.g., auction platform 162) may:
   i. add a Deal-ID (e.g., Deal-ID 158) for the Value-Add Distributor (e.g., VAD 152); and
   ii. send bid requests (not shown) to multiple DSPs (e.g., DSPs 150).
The DSPs (e.g., DSPs 150) may submit bids (e.g., bids 144) for what they will pay to insert an advert (e.g., advertisement 106). Only those DSPs (e.g., DSP 150) that recognize the Deal-ID (e.g., Deal-ID 158) will submit bids.
The Curation Ad-Exchange (e.g., auction platform 162) may pick the highest bid (e.g., bid 144) and may connect the winning DSP (e.g., DSP 150) to the SSP ad tag (e.g., included within advert target information 110).
The winning DSP (e.g., DSP 150) may deliver the Value-Add Creative (e.g., advertisement 106) to the SSP ad tag (e.g., advertisement 106), wherein this Value-Add Creative (e.g., advertisement 106) may be displayed to the viewer (e.g., viewer 100).
The payment from the winning DSP (e.g., DSP 150) may be split between the SSP (e.g., SSP 112) and the Value-Add Distributor (e.g., VAD 152) by the Curation Ad-Exchange (e.g., auction platform 162).

Using a Customized Ad-Exchange
The viewer (e.g., viewer 100) may visit a web page (e.g., content 102).
The web page (e.g., content 102) may contain an SSP ad tag (e.g., included within advert target information 110), which may request an advert (e.g., advertisement 106) from the Customized Ad-Exchange (e.g., auction platform 162).
The Customized Ad-Exchange (e.g., auction platform 162) may send bid requests (not shown) to multiple DSPs (e.g., DSPs 150).
These DSPs (e.g., DSPs 150) may submit bids (e.g., bids 144) concerning what they will pay to insert an advert (e.g., advertisement 106).
The Customized Ad-Exchange (e.g., auction platform 162) may pick the highest bid, wherein the winning DSP (e.g., DSP 144) may provide an advertiser creative (e.g., advertiser creative 160).
The Customized Ad-Exchange (e.g., auction platform 162) may combine the advertiser creative (e.g., advertiser creative 160) with a Value-Add Creative template (e.g., Value-Add Creative template 164) to create the Value-Add Creative (e.g., advertisement 106), wherein this templating may be implemented using macros.
The Customized Ad-Exchange (e.g., auction platform 162) may deliver the Value-Add Creative (e.g., advertisement 106) to the SSP ad tag (e.g., included within advert target information 110), and the Value-Add Creative (e.g., advertisement 106) may be displayed to the viewer (e.g., viewer 100).
The payment from the winning DSP (e.g., DSP 150) may be split between the SSP (e.g., SSP 112) and the Value-Add Distributor (e.g., VAD 152) by the Customized Ad-Exchange (e.g., auction platform 162).

General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method executed on a computing device comprising:
obtaining advert target information for a primary advert auction concerning a viewer of content, wherein the primary advert auction solicits bids for providing an advertisement to the viewer of the content, thus resulting in one or more primary bids;
initiating a secondary advert auction based, at least in part, upon the advert target information, wherein the secondary advert auction solicits bids for providing the advertisement to the viewer of the content while requiring a donation to a charity, thus resulting in one or more secondary bids; and
inserting at least one of the secondary bids into the one or more primary bids so that the at least one of the secondary bids may be considered when determining a winner of the primary advert auction.

2. The computer-implemented method of claim 1 wherein inserting at least one of the secondary bids into the one or more primary bids so that the at least one of the secondary bids may be considered when determining a winner of the primary advert auction includes:
inserting all of the secondary bids into the one or more primary bids so that all of the secondary bids may be considered when determining a winner of the primary advert auction.

3. The computer-implemented method of claim 1 further comprising:
if one of the secondary bids is determined to be the winner of the primary advert auction, offering to make the donation to the charity in exchange for the viewer of the content watching the advertisement.

4. The computer-implemented method of claim 3 further comprising:
enabling the viewer of the content to select the charity.

5. The computer-implemented method of claim 4 wherein enabling the viewer of the content to select the charity includes:
enabling the viewer of the content to select the charity from a plurality of predefined charities.

6. The computer-implemented method of claim 4 wherein enabling the viewer of the content to select the charity includes:
enabling the viewer of the content to predefine a preferred charity.

7. The computer-implemented method of claim 1 wherein the advert target information includes one or more of:
demographic information concerning the viewer;
viewing information concerning the content; and
platform information.

8. The computer-implemented method of claim 1 wherein the advert target information is defined within an advert auction offer for bids.

9. The computer-implemented method of claim 1 wherein the donation to the charity is based upon a percentage of a secondary bid.

10. The computer-implemented method of claim 1 wherein the donation to the charity is a fixed amount.

11. A computer program product residing on a computer readable medium having a plurality of instructions stored thereon which, when executed by a processor, cause the processor to perform operations comprising:
obtaining advert target information for a primary advert auction concerning a viewer of content, wherein the primary advert auction solicits bids for providing an advertisement to the viewer of the content, thus resulting in one or more primary bids;
initiating a secondary advert auction based, at least in part, upon the advert target information, wherein the secondary advert auction solicits bids for providing the advertisement to the viewer of the content while requiring a donation to a charity, thus resulting in one or more secondary bids; and
inserting at least one of the secondary bids into the one or more primary bids so that the at least one of the secondary bids may be considered when determining a winner of the primary advert auction.

12. The computer program product of claim 11 wherein inserting at least one of the secondary bids into the one or more primary bids so that the at least one of the secondary bids may be considered when determining a winner of the primary advert auction includes:
inserting all of the secondary bids into the one or more primary bids so that all of the secondary bids may be considered when determining a winner of the primary advert auction.

13. The computer program product of claim 11 further comprising:
if one of the secondary bids is determined to be the winner of the primary advert auction, offering to make the donation to the charity in exchange for the viewer of the content watching the advertisement.

14. The computer program product of claim 13 further comprising:
enabling the viewer of the content to select the charity.

15. The computer program product of claim 14 wherein enabling the viewer of the content to select the charity includes:
enabling the viewer of the content to select the charity from a plurality of predefined charities.

16. The computer program product of claim 14 wherein enabling the viewer of the content to select the charity includes:
enabling the viewer of the content to predefine a preferred charity.

17. The computer program product of claim 11 wherein the advert target information includes one or more of:
demographic information concerning the viewer;
viewing information concerning the content; and
platform information.

18. The computer program product of claim 11 wherein the advert target information is defined within an advert auction offer for bids.

19. The computer program product of claim 11 wherein the donation to the charity is based upon a percentage of a secondary bid.

20. The computer program product of claim 11 wherein the donation to the charity is a fixed amount.

21. A computing system including a processor and memory configured to perform operations comprising:
obtaining advert target information for a primary advert auction concerning a viewer of content, wherein the primary advert auction solicits bids for providing an advertisement to the viewer of the content, thus resulting in one or more primary bids;
initiating a secondary advert auction based, at least in part, upon the advert target information, wherein the secondary advert auction solicits bids for providing the advertisement to the viewer of the content while requiring a donation to a charity, thus resulting in one or more secondary bids; and
inserting at least one of the secondary bids into the one or more primary bids so that the at least one of the secondary bids may be considered when determining a winner of the primary advert auction.

22. The computing system of claim 21 wherein inserting at least one of the secondary bids into the one or more primary bids so that the at least one of the secondary bids may be considered when determining a winner of the primary advert auction includes:
inserting all of the secondary bids into the one or more primary bids so that all of the secondary bids may be considered when determining a winner of the primary advert auction.

23. The computing system of claim 21 further comprising:
if one of the secondary bids is determined to be the winner of the primary advert auction, offering to make the donation to the charity in exchange for the viewer of the content watching the advertisement.

24. The computing system of claim 23 further comprising:
enabling the viewer of the content to select the charity.

25. The computing system of claim 24 wherein enabling the viewer of the content to select the charity includes:
enabling the viewer of the content to select the charity from a plurality of predefined charities.

26. The computing system of claim 24 wherein enabling the viewer of the content to select the charity includes:
enabling the viewer of the content to predefine a preferred charity.

27. The computing system of claim 21 wherein the advert target information includes one or more of:
demographic information concerning the viewer;
viewing information concerning the content; and
platform information.

28. The computing system of claim 21 wherein the advert target information is defined within an advert auction offer for bids.

29. The computing system of claim 21 wherein the donation to the charity is based upon a percentage of a secondary bid.

30. The computing system of claim 21 wherein the donation to the charity is a fixed amount.
